(19) United States
(12) Patent Application Publication
(10) Pub. No.: US 2025/0013482 A1
(43) Pub. Date: Jan. 9, 2025

(54) ADAPTIVE MIGRATION ESTIMATION FOR A GROUP OF VIRTUAL COMPUTING INSTANCES

(71) Applicant: VMWARE, INC., Palo Alto, CA (US)

(72) Inventors: BHAVESH SHARMA, Bangalore (IN); SUMIT KUMAR, Bangalore (IN); VIPUL PATEL, Bangalore (IN); VEMANA MURTY, Bangalore (IN)

(21) Appl. No.: 18/236,969

(22) Filed: Aug. 23, 2023

(30) Foreign Application Priority Data
Jul. 6, 2023 (IN) 202341045456

(51) Int. Cl. G06F 9/455

(52) U.S. Cl. CPC G06F 9/45558; G06F 2009/4557

(57) ABSTRACT

System and computer-implemented method for predicting durations for virtual computing instance migrations between computing environments calculates initial estimated migration durations for virtual computing instances of a group based on the total available resources and the number of active virtual computing instances being migrated. Revised estimated migration durations are then calculated for at least one of the virtual computing instances of the group selected for migration based on the total available resources and the number of current active virtual computing instances being migrated when migration of at least one of the virtual computing instances of the group is predicted to complete before other virtual computing instances of the group. The revised migration durations are associated with a duration migration prediction for the group of virtual computing instances from a source computing environment to a destination computer environment.

### RELATED APPLICATIONS

Benefit is claimed under 35 U.S.C. 119 (a)-(d) to Foreign application Ser. No. 202341045456 filed in India entitled “ADAPTIVE MIGRATION ESTIMATION FOR A GROUP OF VIRTUAL COMPUTING INSTANCES”, on Jul. 6, 2023, by VMware, Inc., which is herein incorporated in its entirety by reference for all purposes.

### BACKGROUND

Cloud architectures are used in cloud computing and cloud storage systems for offering infrastructure-as-a-service (IaaS) cloud services. Examples of cloud architectures include the VMware Cloud architecture software, Amazon EC2™ web service, and OpenStack™ open source cloud computing service. IaaS cloud service is a type of cloud service that provides access to physical and/or virtual resources in a cloud environment. These services provide a tenant application programming interface (API) that supports operations for manipulating IaaS constructs, such as virtual computing instances (VCIs), e.g., virtual machines (VMs), and logical networks.

A cloud system may aggregate the resources from both private and public clouds. A private cloud can include one or more customer data centers (referred to herein as “on-premise data centers”). A public cloud can include a multi-tenant cloud architecture providing IaaS cloud services. In a cloud system, it is desirable to support VCI migration between different private clouds, between different public clouds and between a private cloud and a public cloud for various reasons, such as workload management.

Workload migration in case of datacenter consolidation and evacuation is a cumbersome process that involves multiple stages, for example, viz., identifying candidate VMs, putting together subset of these VMs into one or more groups based on some business criteria and eventually scheduling this wave of migrations in a way that VM groups are migrated to the target in a certain order. The scheduling step needs to estimate the migration completion time of the selected VMs in each group, which can be difficult, as explained below.

In a typical VM group migration process, migrating selected VMs at a source cloud to a destination cloud involves a data replication phase and a cutover phase. The data replication phase includes transferring a copy of each VM data from the source cloud to the destination cloud. After the data replication phase has been completed, the cutover phase can be performed to bring up the VMs at the destination cloud. However, estimating the completion time for each VM group migration is challenging because the data replication phase of the VM group migration is influenced by many system parameters at both the source and destination clouds, as well as the size of the VMs.

Thus, the scheduling step of a workload migration needs careful assessment of VM characteristics and system parameters of both source and destination clouds to arrive at a specific schedule for each group based on the tentative completion time of the preceding group, which can vary to a great extent based on ever changing workload and system parameters.

### SUMMARY

System and computer-implemented method for predicting durations for virtual computing instance migrations between computing environments calculates initial estimated migration durations for virtual computing instances of a group based on total available resources and the number of active virtual computing instances being migrated. Revised estimated migration durations are then calculated for at least one of the virtual computing instances of the group selected for migration based on the total available resources and the number of current active virtual computing instances being migrated when migration of at least one of the virtual computing instances of the group is predicted to complete before other virtual computing instances of the group. The revised migration durations are associated with a duration migration prediction for the group of virtual computing instances from a source computing environment to a destination computer environment.

A computer-implemented method for predicting durations for virtual computing instance migrations between computing environments in accordance with an embodiment of the invention comprises receiving a request for a migration prediction duration of a group of virtual computing instances from a source computing environment to a destination computing environment, in response to the request, calculating initial estimated migration durations for the virtual computing instances of the group based on the total available resources and the number of active virtual computing instances being migrated, and calculating revised estimated migration durations for at least one of the virtual computing instances of the group selected for migration based on the total available resources and the number of current active virtual computing instances being migrated when migration of at least one of the virtual computing instances of the group is predicted to complete before other virtual computing instances of the group, wherein the revised estimated migration durations are associated with a migration duration prediction for the group of virtual computing instances from a source computing environment to a destination computer environment. In some embodiments, the steps of this method are performed when program instructions contained in a computer-readable storage medium are executed by one or more processors.

A system in accordance with an embodiment of the invention comprises memory and one or more processors configured to receive a request for a migration prediction duration of a group of virtual computing instances from a source computing environment to a destination computing environment, in response to the request, calculate initial estimated migration durations for the virtual computing instances of the group based on the total available resources and the number of active virtual computing instances being migrated, and calculate revised estimated migration durations for at least one of the virtual computing instances of the group selected for migration based on the total available resources and the number of current active virtual computing instances being migrated when migration of at least one of the virtual computing instances of the group is predicted to complete before other virtual computing instances of the group, wherein the revised estimated migration durations are associated with a migration duration prediction for the group of virtual computing instances from a source computing environment to a destination computer environment.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 is a block diagram of a cloud system in which embodiments of the invention may be implemented.

FIG. 2 shows components of a migration prediction system in the cloud system depicted in FIG. 1 in accordance with an embodiment of the invention.

FIG. 3 is a flow diagram of the prediction process executed by the migration prediction system in accordance with an embodiment of the invention.

FIG. 4 is an illustration of a data collection process executed by a data collector of the migration prediction system in accordance with an embodiment of the invention.

FIG. 5 illustrates normalization function metadata in accordance with an embodiment of the invention.

FIG. 6 illustrates the normalization process executed by a data normalization subsystem of the migration prediction system for a group migration of VMs in accordance with an embodiment of the invention.

FIG. 7 illustrates the training operation executed by a training subsystem of the migration prediction system for a group migration of VMs in accordance with an embodiment of the invention.

FIG. 8 illustrates original and readjusted migration time estimations for a mobility group of VMs calculated by the migration prediction system in accordance with an embodiment of the invention.

FIG. 9 illustrates updated migration estimation times for a group of VMs in accordance with an embodiment of the invention.

FIG. 10 illustrates the prediction operation of a prediction subsystem of the migration prediction system in accordance with an embodiment of the invention.

FIG. 11 is a process flow diagram of a computer-implemented method for predicting durations for virtual computing instance migrations between computing environments in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

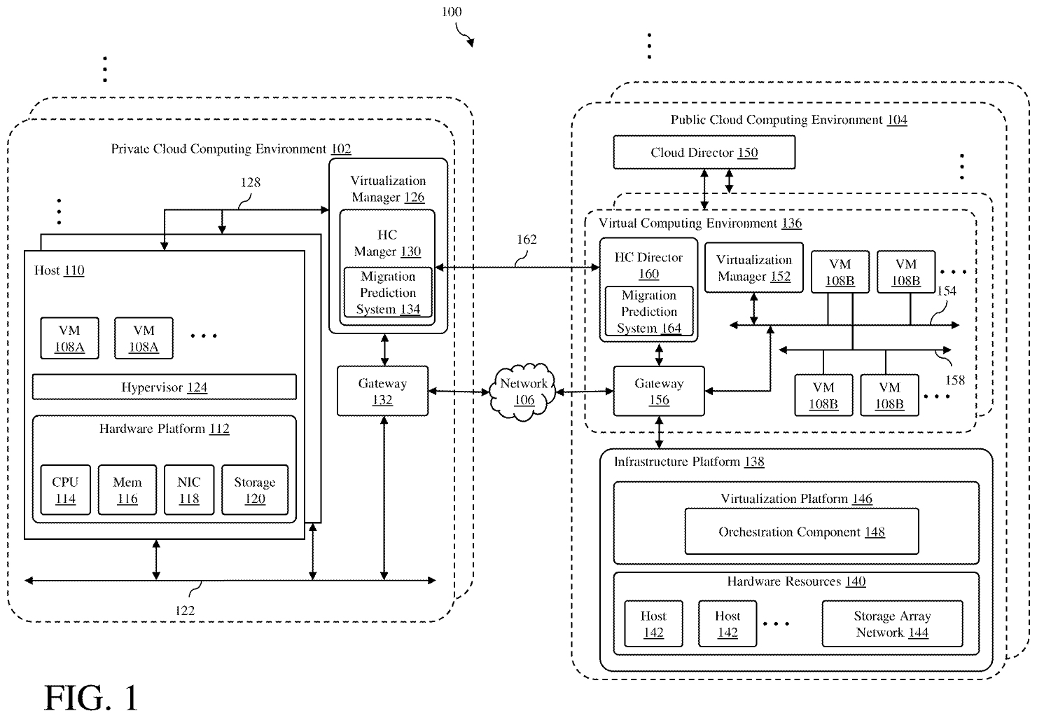

Turning now to FIG. 1, a block diagram of a cloud system 100 in which embodiments of the invention may be implemented in accordance with an embodiment of the invention is shown. The cloud system 100 includes one or more private cloud computing environments 102 and/or one or more public cloud computing environments 104 that are connected via a network 106. The cloud system 100 is configured to provide a common platform for managing and executing workloads seamlessly between the private and public cloud computing environments. In one embodiment, one or more private cloud computing environments 102 may be controlled and administrated by a particular enterprise or business organization, while one or more public cloud computing environments 104 may be operated by a cloud computing service provider and exposed as a service available to account holders, such as the particular enterprise in addition to other enterprises. In some embodiments, each private cloud computing environment 102 may be a private or on-premise data center.

The private and public cloud computing environments 102 and 104 of the cloud system 100 include computing and/or storage infrastructures to support a number of virtual computing instances 108A and 108B. As used herein, the term “virtual computing instance” refers to any software processing entity that can run on a computer system, such as a software application, a software process, a virtual machine (VM), e.g., a VM supported by virtualization products of VMware, Inc., and a software “container”, e.g., a Docker container. However, in this disclosure, the virtual computing instances will be described as being virtual machines, although embodiments of the invention described herein are not limited to virtual machines.

As explained below, the cloud system 100 supports migration of the virtual machines 108A and 108B between any of the private and public cloud computing environments 102 and 104. The cloud system 100 may also support migration of the virtual machines 108A and 108B between different sites situated at different physical locations, which may be situated in different private and/or public cloud computing environments 102 and 104 or, in some cases, the same computing environment.

As shown in FIG. 1, each private cloud computing environment 102 of the cloud system 100 includes one or more host computer systems (“hosts”) 110. The hosts may be constructed on a server grade hardware platform 112, such as an x86 architecture platform. As shown, the hardware platform of each host may include conventional components of a computing device, such as one or more processors (e.g., CPUs) 114, system memory 116, a network interface 118, storage system 120, and other I/O devices such as, for example, a mouse and a keyboard (not shown). The processor 114 is configured to execute instructions, for example, executable instructions that perform one or more operations described herein and may be stored in the memory 116 and the storage system 120. The memory 116 is volatile memory used for retrieving programs and processing data. The memory 116 may include, for example, one or more random access memory (RAM) modules. The network interface 118 enables the host 110 to communicate with another device via a communication medium, such as a network 122 within the private cloud computing environment. The network interface 118 may be one or more network adapters, also referred to as a Network Interface Card (NIC). The storage system 120 represents local storage devices (e.g., one or more hard disks, flash memory modules, solid state disks and optical disks) and/or a storage interface that enables the host to communicate with one or more network data storage systems. Example of a storage interface is a host bus adapter (HBA) that couples the host to one or more storage arrays, such as a storage area network (SAN) or a network-attached storage (NAS), as well as other network data storage systems. The storage system 120 is used to store information, such as executable instructions, cryptographic keys, virtual disks, configurations and other data, which can be retrieved by the host.

Each host 110 may be configured to provide a virtualization layer that abstracts processor, memory, storage and networking resources of the hardware platform 112 into the virtual computing instances, e.g., the virtual machines 108A, that run concurrently on the same host. The virtual machines run on top of a software interface layer, which is referred to herein as a hypervisor 124, that enables sharing of the hardware resources of the host by the virtual machines. One example of the hypervisor 124 that may be used in an embodiment described herein is a VMware ESXi™ hypervisor provided as part of the VMware vSphere® solution made commercially available from VMware, Inc. The hypervisor 124 may run on top of the operating system of the host or directly on hardware components of the host. For other types of virtual computing instances, the host may include other virtualization software platforms to support those virtual computing instances, such as Docker virtualization platform to support software containers.

Each private cloud computing environment 102 includes a virtualization manager 126 that communicates with the hosts 110 via a management network 128. In an embodiment, the virtualization manager 126 is a computer program that resides and executes in a computer system, such as one of the hosts 110, or in a virtual computing instance, such as one of the virtual machines 108A running on the hosts. One example of the virtualization manager 126 is the VMware vCenter Server® product made available from VMware, Inc. The virtualization manager 126 is configured to carry out administrative tasks for the private cloud computing environment 102, including managing the hosts, managing the virtual machines running within each host, provisioning virtual machines, deploying virtual machines, migrating virtual machines from one host to another host, and load balancing between the hosts.

In one embodiment, the virtualization manager 126 includes a hybrid cloud (HC) manager 130 configured to manage and integrate computing resources provided by the private cloud computing environment 102 with computing resources provided by one or more of the public cloud computing environments 104 to form a unified “hybrid” computing platform. The hybrid cloud manager is responsible for migrating/transferring virtual machines between the private cloud computing environment and one or more of the public cloud computing environments, and perform other “cross-cloud” administrative tasks. In one implementation, the hybrid cloud manager 130 is a module or plug-in to the virtualization manager 126, although other implementations may be used, such as a separate computer program executing in any computer system or running in a virtual machine in one of the hosts. One example of the hybrid cloud manager 130 is the VMware® HCX™ product made available from VMware, Inc.

In the illustrated embodiment, the HC manager 130 includes a migration prediction system 134, which operates to provide predictions of data replication process durations related to migrations of virtual computing instances, e.g., VMs, between the private cloud computing environment 102 to other computing environments, such as the public cloud computing environment 104 or another private cloud computing environment. Although the migration prediction system 134 is shown to reside in the hybrid cloud manager 130, the migration prediction system 134 may reside anywhere in the private cloud computing environment 102 or in another computing environment in other embodiments. The migration prediction system 134 and its operations will be described in detail below.

In one embodiment, the hybrid cloud manager 130 is configured to control network traffic into the network 106 via a gateway device 132, which may be implemented as a virtual appliance. The gateway device 132 is configured to provide the virtual machines 108A and other devices in the private cloud computing environment 102 with connectivity to external devices via the network 106. The gateway device 132 may manage external public Internet Protocol (IP) addresses for the virtual machines 108A and route traffic incoming to and outgoing from the private cloud computing environment and provide networking services, such as firewalls, network address translation (NAT), dynamic host configuration protocol (DHCP), load balancing, and virtual private network (VPN) connectivity over the network 106.

Each public cloud computing environment 104 of the cloud system 100 is configured to dynamically provide an enterprise (or users of an enterprise) with one or more virtual computing environments 136 in which an administrator of the enterprise may provision virtual computing instances, e.g., the virtual machines 108B, and install and execute various applications in the virtual computing instances. Each public cloud computing environment includes an infrastructure platform 138 upon which the virtual computing environments can be executed. In the particular embodiment of FIG. 1, the infrastructure platform 138 includes hardware resources 140 having computing resources (e.g., hosts 142), storage resources (e.g., one or more storage array systems, such as a storage area network (SAN) 144), and networking resources (not illustrated), and a virtualization platform 146, which is programmed and/or configured to provide the virtual computing environments 136 that support the virtual machines 108B across the hosts 142. The virtualization platform may be implemented using one or more software programs that reside and execute in one or more computer systems, such as the hosts 142, or in one or more virtual computing instances, such as the virtual machines 108B, running on the hosts.

In one embodiment, the virtualization platform 146 includes an orchestration component 148 that provides infrastructure resources to the virtual computing environments 136 responsive to provisioning requests. The orchestration component may instantiate virtual machines according to a requested template that defines one or more virtual machines having specified virtual computing resources (e.g., compute, networking and storage resources). Further, the orchestration component may monitor the infrastructure resource consumption levels and requirements of the virtual computing environments and provide additional infrastructure resources to the virtual computing environments as needed or desired. In one example, similar to the private cloud computing environments 102, the virtualization platform may be implemented by running on the hosts 142 VMware ESXi™-based hypervisor technologies provided by VMware, Inc. However, the virtualization platform may be implemented using any other virtualization technologies, including Xen®, Microsoft Hyper-V® and/or Docker virtualization technologies, depending on the virtual computing instances being used in the public cloud computing environment 104.

In one embodiment, each public cloud computing environment 104 may include a cloud director 150 that manages allocation of virtual computing resources to an enterprise. The cloud director may be accessible to users via a REST (Representational State Transfer) API (Application Programming Interface) or any other client-server communication protocol. The cloud director may authenticate connection attempts from the enterprise using credentials issued by the cloud computing provider. The cloud director receives provisioning requests submitted (e.g., via REST API calls) and may propagate such requests to the orchestration component 148 to instantiate the requested virtual machines (e.g., the virtual machines 108B). One example of the cloud director is the VMware vCloud Director® product from VMware, Inc. The public cloud computing environment 104 may be VMware cloud (VMC) on Amazon Web Services (AWS).

In one embodiment, at least some of the virtual computing environments 136 may be configured as virtual data centers. Each virtual computing environment includes one or more virtual computing instances, such as the virtual machines 108B, and one or more virtualization managers 152. The virtualization managers 152 may be similar to the virtualization manager 126 in the private cloud computing environments 102. One example of the virtualization manager 152 is the VMware vCenter Server® product made available from VMware, Inc. Each virtual computing environment may further include one or more virtual networks 154 used to communicate between the virtual machines 108B running in that environment and managed by at least one networking gateway device 156, as well as one or more isolated internal networks 158 not connected to the gateway device 156. The gateway device 156, which may be a virtual appliance, is configured to provide the virtual machines 108B and other components in the virtual computing environment 136 with connectivity to external devices, such as components in the private cloud computing environments 102 via the network 106. The gateway device 156 operates in a similar manner as the gateway device 132 in the private cloud computing environments.

In one embodiment, each virtual computing environments 136 includes a hybrid cloud (HC) director 160 configured to communicate with the corresponding hybrid cloud manager 130 in at least one of the private cloud computing environments 102 to enable a common virtualized computing platform between the private and public cloud computing environments. The hybrid cloud director 160 may communicate with the hybrid cloud manager 130 using Internet-based traffic via a VPN tunnel established between the gateways 132 and 156, or alternatively, using a direct connection 162. The hybrid cloud director 160 and the corresponding hybrid cloud manager 130 facilitate cross-cloud migration of virtual computing instances, such as virtual machines 108A and 108B, between the private and public computing environments. This cross-cloud migration may include “cold migration”, which refers to migrating a VM which is always powered off throughout the migration process, “hot migration”, which refers to live migration of a VM where the VM is always in powered on state without any disruption, and “bulk migration”, which is a combination where a VM remains powered on during the replication phase but is briefly powered off, and then eventually turned on at the end of the cutover phase. The hybrid cloud managers and directors in different computing environments, such as the private cloud computing environment 102 and the virtual computing environment 136, operate to enable migrations between any of the different computing environments, such as between private cloud computing environments, between public cloud computing environments, between a private cloud computing environment and a public cloud computing environment, between virtual computing environments in one or more public cloud computing environments, between a virtual computing environment in a public cloud computing environment and a private cloud computing environment, etc. As used herein, “computing environments” include any computing environment, including data centers. As an example, the hybrid cloud director 160 may be a component of the HCX-Cloud product and the hybrid cloud manager 130 may be a component of the HCX-Enterprise product, which are provided by VMware, Inc.

As shown in FIG. 1, the hybrid cloud director 160 includes a migration prediction system 164, which may be a cloud version of a migration prediction system similar to the migration prediction system 134. The migration prediction system 164 in the virtual computing environment 136 and the migration prediction system 134 in the private cloud computing environment 102 cooperatively operate to provide predictions of data replication process durations related to migrations of virtual computing instances, e.g., VMs, between the private cloud computing environment 102 to other computing environments, such as the public cloud computing environment 104 or another private cloud computing environment.

The migrations of VMs may be performed in a bulk and planned manner in a way so as not to affect the business continuity. In an embodiment, a migration is performed in two phases, a replication phase (initial copy of each VM being migrated) and then a cutover phase. The replication phase involves copying and transferring the entire VM data from the source computing environment to the destination computing environment. The replication phase may also involve periodically transferring delta data (new data) from the VM, which continues to run during the replication phase, to the destination computing environment. The cutover phase may involve powering off the original source VM at the source computing environment, flushing leftover virtual disk of the source VM to the destination computing environment, and then creating and powering on a new VM at the destination computing environment. The cutover phase may cause brief downtime of services hosted on the migrated VM. Hence, it is extremely critical to plan this cutover phase in a way that business continuity is minimally affected. The precursor to the cutover phase being successful is a completion of the initial copy, i.e., the replication phase or process. Thus, it is very useful to have an insight into the overall transfer time of the replication process so that administrators can schedule the cutover window accordingly. The migration prediction systems 134 and 164 in accordance with embodiments of the invention provide a robust prediction or estimation of the expected duration of the replication process of a migration of VMs. As explained below, the prediction or estimation is based at least partly on resources that become available as one or more VMs are predicted to complete and the number of VMs selected for migration for the prediction calculation.

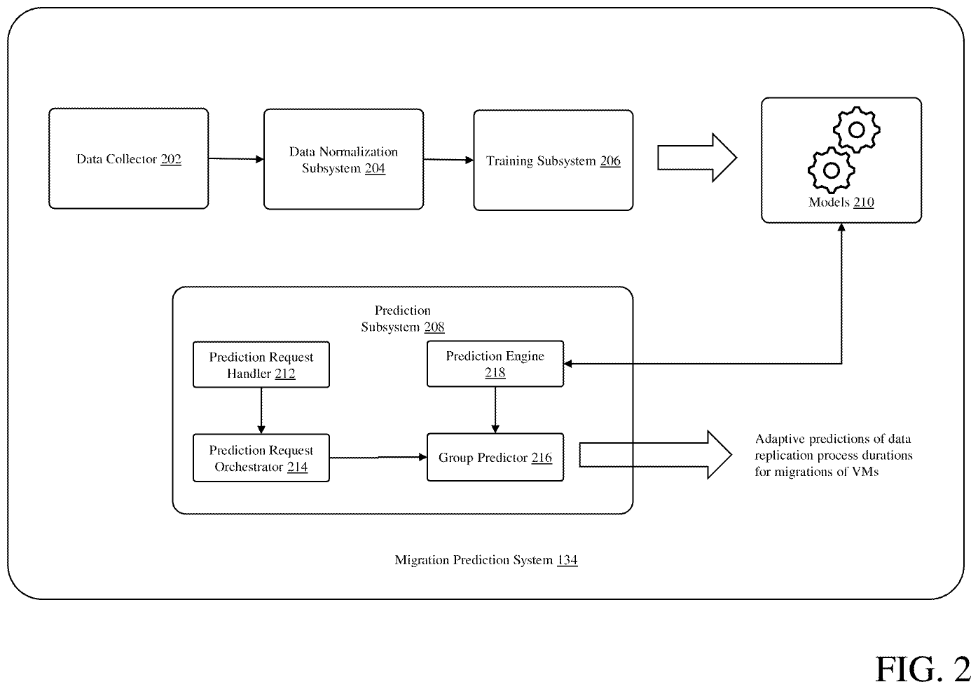

Turning now to FIG. 2, components of the migration prediction system 134 in the hybrid cloud manager 130 of the private cloud computing environment 102 in accordance with an embodiment of the invention are shown. The migration prediction system 164 in the hybrid cloud director 160 of the virtual computing environment 136 or in other computer networks may include similar components. As shown in FIG. 2, the migration prediction system 134 includes a data collector 202, a data normalization subsystem 204, a training subsystem 206, and a prediction subsystem 208. The data collector 202, the data normalization subsystem 204 and the training subsystem 206 operate to train computer (machine learning) models 210, which are used by the prediction subsystem 208 to adaptively and iteratively generate predictions of data replication process durations for migration of VMs in a mobility group of VMs between computing environments.

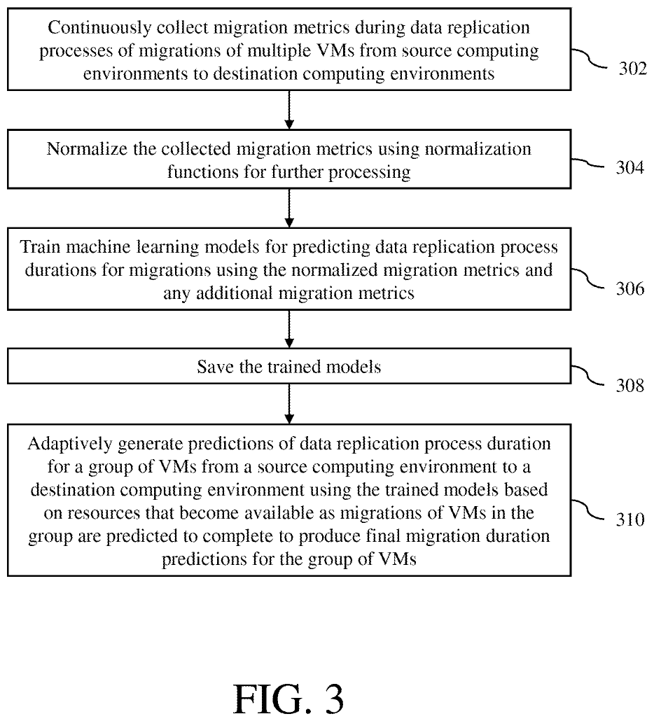

The prediction process executed by the migration prediction system 134 in accordance with an embodiment of the invention is now described with reference to the flow diagram of FIG. 3. The prediction process begins at step 302, where migration metrics during data replication processes of migrations of multiple VMs from source computing environments to destination computing environments are continuously collected by the data collector 202. In an embodiment, for each migration, the migration metrics are collected at the source computing environment and the destination computing environment, and synchronized so that all the migration metrics for the migration are available at both the source and destination computing environments.

After the migration metrics for a set number of migrations have been collected, step 304 is performed, where the collected migration metrics are normalized using normalization functions for further processing by the data normalization subsystem 204. In addition, one or more additional migration metrics, e.g., data transfer rate, may be computed using some of these normalized migration metrics by the data normalization subsystem 204. Furthermore, the normalized migration metrics and any additional migration metrics may be converted by the normalization subsystem 204 to a suitable format for the training subsystem 206 to use, for example, a vector of normalized migration metrics.

Next, at step 306, machine learning models for predicting data replication process durations for migrations are trained by the training subsystem 206 using the normalized migration metrics and any additional migration metrics derived from some of the normalized migration metrics. At step 308, the trained models 210 are saved to be used for predictions of data replication process durations for future migrations.

Next, at step 310, predictions of data replication process duration for a group of VMs from a source computing environment to a destination computing environment are adaptively generated by the prediction subsystem 208 using the trained models 210 based on resources that become available as migrations of VMs in the group are predicted to complete to produce final migration duration predictions for the group of VMs. This adaptive generation step is described in detail below.

The components of the migration prediction system 134 and their operations in accordance with embodiments of the invention are described in detail below.

The data collector 202 of the migration prediction system 134 is responsible for collecting migration metrics or samples that are required for making heuristic-based predictions for data replication process duration for each of the migrating VMs. The initial transfer, which is a replication or copying process, is a function of various parameters, such as, but not limited to, VM size, data transfer rate, data checksum rate, the type of storage and its performance at source and destination computer environments, and/or the performance of the network being used for the transfer, e.g., wide area network (WAN) pipe.

During the transfer or replication phase, metrics are collected both on the source and destination sides by their respective data collectors 202. These metrics are then synchronized to the other side by the data collectors to make sure that the entire data space is available in its entirely that is suitable for model building at both sides. In order to determine the sampling rate to collect the metrics, the VMs being migrated are categorized into different buckets based on their size. For example, VMs may be categorized into three (3) buckets, a small bucket (e.g., <50 gigabyte (GB)), a medium bucket (e.g., <1 terabyte (TB) and a large bucket (e.g., >1 TB). These buckets drive the frequency with which the metrics are sampled by the data collector 202. This is important since transfer for larger VMs will take longer than smaller VMs. For a large VM, which may take days to transfer, a high frequency of sampling may overload the system, and thus, should be sampled at a low frequency. On the other hand, a small VM might need to be sampled more frequently to ensure enough metrics are sampled to learn its behavior. Thus, in an embodiment, large VMs are sampled at a low frequency (e.g., one sample every 15 min), medium VMs are sampled at a medium frequency (e.g., one sample every 7.5 min), and small VMs are sampled at a high frequency (e.g., one sample every 3 min)

In an embodiment, the following migration metrics may be collected from each VM while in migration:
bytes transferred—number of bytes that have been transferred during the migration.
checksum bytes—bytes for which checksum has been performed during the migration.
concurrent migrations—number of concurrent VM migrations.
number of disks—number of disks attached to the VM.
disk size in bytes—size of each disk size of the VM being migrated.
source datastore—datastore that the VM is using at the source side and the corresponding type.
target datastore—datastore that the migrated VM will land on at the target side.
appliance count—number of appliance pair configured between the sites for the data transfer.
data churn rate—guest input/output (IO) activity inside the VM.
appliance pair—specific appliance pair via which migration traffic is steered.

Furthermore, additional migration metrics may be derived from some of these metrics in a data normalization process performed by the data normalization subsystem 204. For example, data transfer rate may be calculated by dividing “data transferred” by “duration of the migration.” Some of these additional metrics may be derived after the metrics have been normalized/transformed by the data normalization subsystem 204.

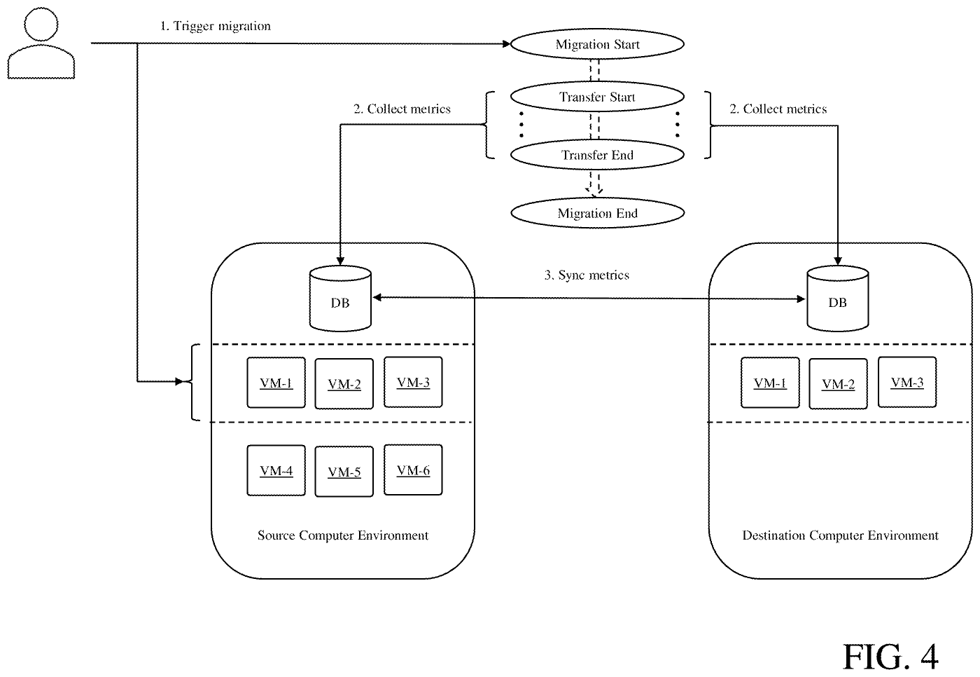

Turning now to FIG. 4, an illustration of a data collection process executed by the data collector 202 in accordance with an embodiment of the invention is illustrated. FIG. 4 shows steps for the collection process. At step 1, virtual machines in a source computing environment are selected by a user for a migration wave (i.e., migration of one or more virtual machines), and a migration process for the migration wave is triggered by the user. In the illustration of FIG. 4, virtual machines VM-1, VM-2 and VM-3 are selected for the migration wave. Thus, the source computer environment is shown to include the virtual machines VM-1, VM-2 and VM-3 that are being migrated. The source computer environment is also shown to include virtual machines VM-4, VM-5 and VM-6, which are virtual machines that are not part of the migration wave.

At step 2, migration metrics are collected at the source and destination computing environments by their respective data collectors 202 during the transfer of data associated with the virtual machines VM-1, VM-2 and VM-3 in the migration process. The collected migration metrics may be stored in a database (DB) at the source and destination computing environments. As noted above, the metrics may be sampled at different frequency depending on the size of the virtual machines being migrated.

At step 3, the migration metrics collected at the source and destination computing environments are synchronized by their respective data collectors 202. Thus, all the collected metrics are available to both data collectors at the source and destination computing environments.

The data normalization subsystem 204 of the migration prediction system 134 is responsible for fetching metadata for each migration type that drives a normalization process and specifies one or more functions to be applied on the collected metric samples to make these metrics consumable for the training subsystem 206. The metadata also prescribes data set requirements for initially creating a model for data replication process duration prediction and for subsequently refreshing the model. For example, the metadata may set the minimum number of seed data sets for initially creating the model at fifty (50) data sets, which equates to having collected metrics for fifty (50) migrations. In addition, the metadata may set the minimum number of additional data sets for subsequently refreshing the model at twenty-five (25) additional data sets.

The data normalization subsystem 204 is also responsible for normalizing the samples collected by the data collectors 204 so that the samples can be consumed by the training subsystem 206. Different samples may require different processing to produce the desired metrics. As an example, for some samples, the maximum value over a series of collected values may be required. For other samples, the summed value of a series of collected values may be required. For each sample, the metadata of the normalization function defines the specific sample type it should process and the transformation to be applied.

Normalization of samples does not happen until metric/samples have reached a minimum threshold of migrations, e.g., fifty (50) migrations. Post which the samples are normalized in an incremental manner for every set migrations, e.g., twenty (25) migrations. Data normalizing is a processing heavy task since for a medium sized VM˜1,000 s of samples may be created. The minimum threshold and incremental threshold ensure that the migration prediction system 134 is not overloaded too frequently while also ensuring the deduced model is in line with the most recent samples.

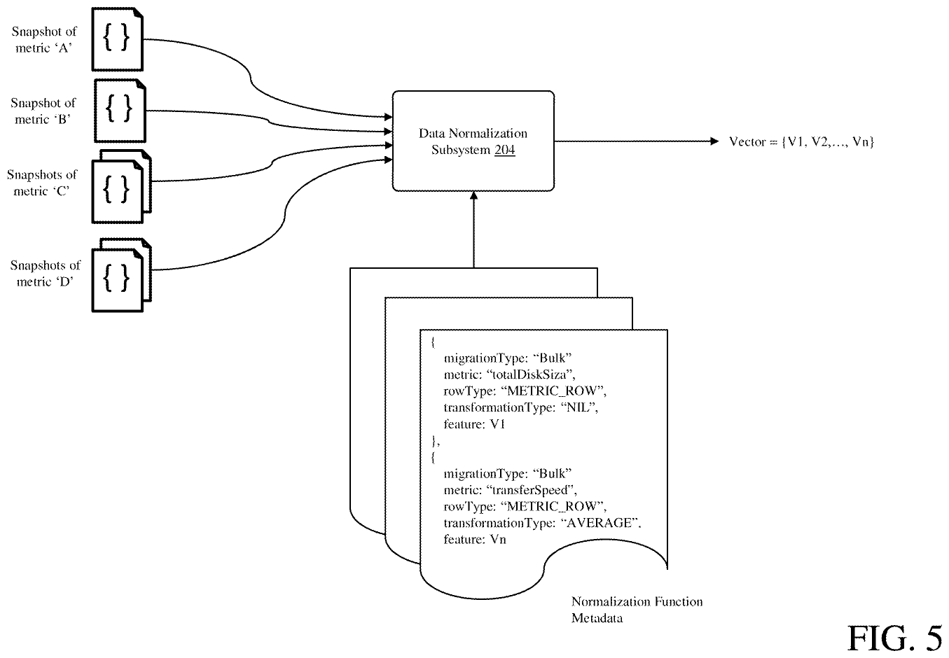

FIG. 5 illustrates normalization function metadata in accordance with an embodiment of the invention that can be used to apply normalization functions on different collected metrics by the data normalization subsystem 204 to produce an output that is consumable for the training subsystem 206. As shown in FIG. 5, samples or snapshots of different metrics, e.g., metrics “A”, “B”, “C” and D, are input to the data normalizing subsystem 204. For each metric type, the corresponding normalization function metadata is fetched. The normalization function metadata may be stored in any storage accessible by the data normalization subsystem 204. Two different normalization function metadata are illustrated in FIG. 5. The top normalization function metadata is for the total disk size metric. The bottom normalization function metadata is for the transfer speed metric. In this example, each metadata includes migration type, metric, row type, transformation type and feature. In addition, the output of the data normalization subsystem 204 is a vector that includes all the processed metrics.

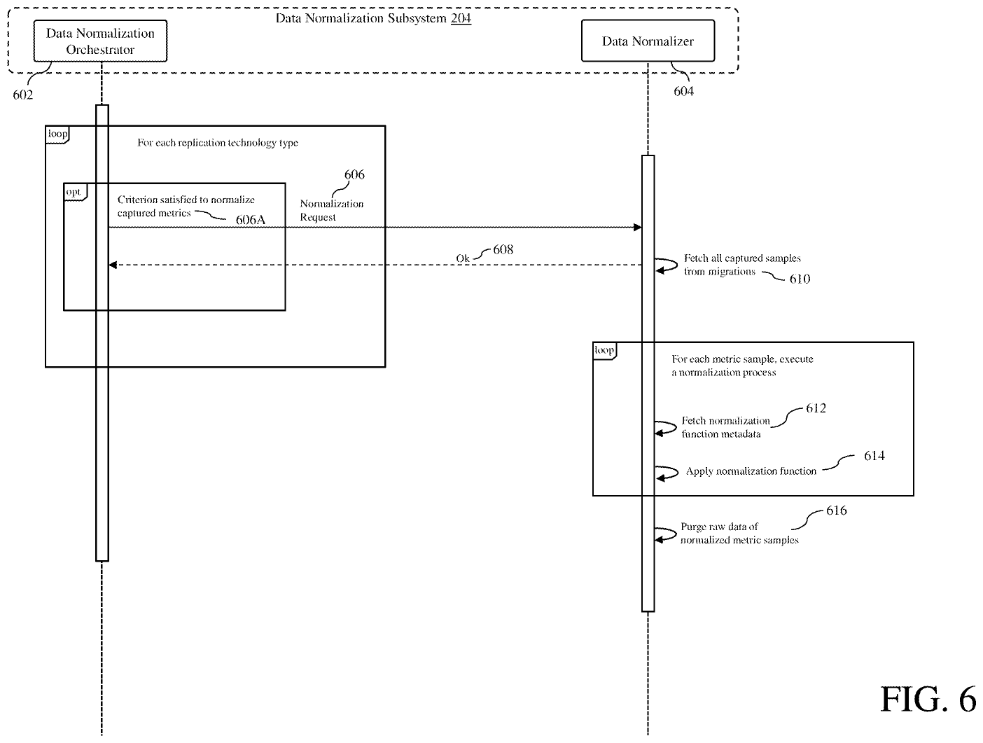

The normalization process executed by the data normalization subsystem 204 for a group migration of VMs, i.e., a migration wave, in accordance with an embodiment of the invention is illustrated in FIG. 6. In this embodiment, the data normalization subsystem 204 includes a data normalization orchestrator 602 and a data normalizer 604. The data normalization orchestrator 602 manages the normalization process, while the data normalizer 604 executes various tasks for the normalization process.

The normalization process begins at step 606, where, for each replication technology type involved in the migrations, a normalization request is transmitted to the data normalizer 604 from the data normalization orchestrator 602 to normalize the captured metrics for the particular technology type. In an embodiment, the normalization request is only sent when an appropriate criterion or threshold with respect to the number of migrations is satisfied to normalize the captured metrics, as indicated by step 606A. As an example, if this is the first time the normalization process is being executed, then a minimum of fifty (50) migrations should have been sampled. However, after the first normalization process, each subsequent normalization process is executed once additional twenty-five (25) migrations have been sampled.

Next, at step 608, in response to the normalization request, an acknowledgement is sent to the data normalization orchestrator 602 from the data normalizer 604. Next, at step 610, captured samples from the migrations are fetched by the data normalizer 602.

Next, for each fetched metric type, steps 612 and 614 are executed. At step 612, for a particular metric type, the corresponding normalization function metadata is fetched by the data normalizer 604. At step 614, the normalization function is applied to the collected samples using the fetched normalization function metadata by the data normalizer 604.

After all the metric types have been processed, the raw data of the normalized samples, i.e., the original captured metric samples, are purged by the data normalizer 604, at step 616. The normalization process then comes to an end.

The training subsystem 206 of the migration prediction system 134 is responsible for producing models that can predict the time needed to complete a particular phase of the migration. In this case, the particular migration phase is the initial transfer, i.e., a replication process, for bulk migration of multiple VMs. The training subsystem 206 may use one or more machine learning algorithms for heuristics with respect to generating the models.

Every migration type uses one or more technologies (e.g., VMware vSphere® Replication™ technology, VMware vSphere® vMotion® technology, etc.) to achieve the migration goal during different phases of migration. In an embodiment, there may be data processors associated with each technology type involved in a group migration. The training subsystem 206 with the help of right data processors creates a model for each of the migration technology types.

In an embodiment, for the transfer phase of bulk migration, a random forest method may be used for heuristics with hyperparameter tuning. K-fold cross-validation paradigm may be used by the training subsystem to train models with different configurations, evaluate the trained models, and find the best model.

In an embodiment, multiple models are trained by the training subsystem 206 based on predefined set of hyperparameter combinations. Each of these models is passed through a k-fold validation process by the training subsystem 206, wherein the same data is sliced differently between train and validation data, and performance is recorded. For all possible combinations of hyperparameters for a given algorithm, k-fold cross-validation is performed over given data.

An optimal model among the trained models is then found and its performance is noted by the training subsystem 206. The existing model for the particular migration technology type is then replaced with the new optimal model.

In order to incorporate changing behavior of the underlying system, the training subsystem 206 is refreshed once sufficient new migrations are performed, which helps the migration prediction system 134 to stay relevant with respect to replication time predictions or estimates. This ensures that the model prediction time is always in sync with the latest dynamics of the underlying system and reduces the difference between the prediction time and the actual time over enhancements.

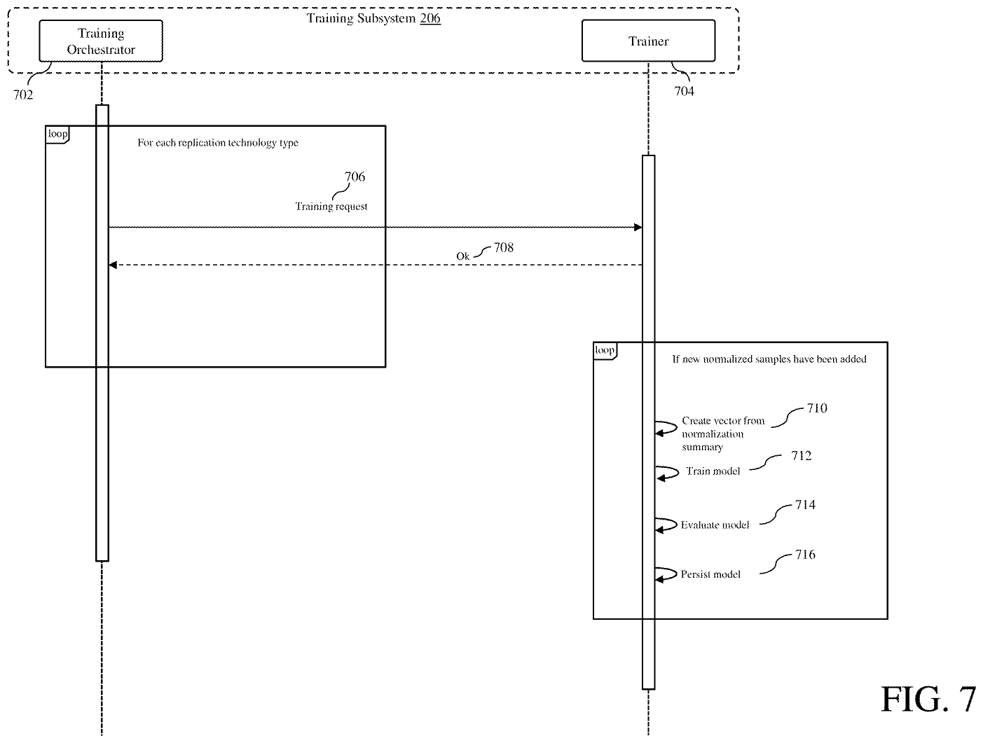

The training operation executed by the training subsystem 206 for a group migration of VMs, i.e., a migration wave, in accordance with an embodiment of the invention is illustrated in FIG. 7. In this embodiment, the training subsystem 206 includes a training orchestrator 702 and a trainer 704. The training orchestrator 702 manages the training operation, while the trainer 704 executes various tasks for the training operation.

The training operation begins at step 706, where, for each replication technology type, a training request is transmitted to the trainer 704 from the training orchestrator 702 to initiate training of a model for the particular replication technology type. Next, at step 708, in response to the training request, an acknowledgement is sent to the training orchestrator 702 from the trainer 704.

Next, steps 710-716 are executed only if new normalized samples have been added. At step 710, a vector is created from a normalized summary by the trainer 704. The normalized summary consists of different types of aggregate functions, such as sum, average, maximum etc., to be applied on the timeseries of raw metrics. Next, at step 712, the model is trained by the trainer 704, as described above using a random forest method and k-fold cross-validation.

Next, at step 714, the trained model is evaluated by the trainer 704. Next, at step 716, the model is persisted or saved on an appropriate storage by the trainer 704 so that the model can be used for data replication process duration predictions. The operation then comes to an end.

The prediction subsystem 208 of the migration prediction system 134 operates to generate predictions for data replication process durations for migrations on behalf of an end user, which may be an administrator. A prediction for a migration is the sum of predictions of each technology type (transfer, switchover etc.) used for the replication. For a migration wave, which consists of one or more VMs that are to be migrated, the predictions are at each VM level. That is, each prediction is for a particular VM in the migration wave.

Turning back to FIG. 2, components of the prediction subsystem 208 in accordance with an embodiment of the invention are illustrated. As shown in FIG. 2, the prediction subsystem 208 includes a prediction request handler 212, a prediction request orchestrator 214, a group predictor 216 and a prediction engine 218.

The prediction request handler 212 operates to handle requests for predictions from users. In particular, when a prediction request is received for one or more migration waves, the prediction request handler 212 is configured to validate the request, assign a prediction identification (ID) for each of the migration waves, and record each prediction ID with the status “New”. The assigned prediction IDs are returned to the requesting user so that the prediction IDs can be used by the user to query the prediction subsystem 208 to check if the predictions are ready and to receive the predictions.

The prediction request orchestrator 214 operates to monitor for “New” prediction requests. When there are “New” prediction requests, some of the “New” prediction requests are selected and passed to the group predictor 216, which may be instantiated by the prediction request orchestrator. In an embodiment, the prediction request orchestrator 214 may throttle or control the number of “New” prediction requests being processed to ensure that the prediction subsystem 208 is not overwhelmed with too many prediction requests.

The group predictor 216 enabled by the prediction request orchestrator 214 uses the prediction engine 218 to generate adaptive iterative estimation based on resources that are available as migration of VMs of a mobility group are completed. The prediction engine 218 operates to predict migration time per VM by extrapolating sample vector from the VM traits, resource availability and the selected source and target parameters. This vector is then subjected to validation against the available models 210 to get the estimated migration time. In an embodiment, the prediction engine 218 uses a prediction function to generate the estimated migration times. Consider a mobility group size of N VMs. For a given VM x, the prediction function may be defined as:

Pₓ=F(Cₓ|r₁,r₂ . . . r_{M},w₁,w₂ . . . w_{M}), where
Cₓ represents vm characteristic vector,
wᵢ represents influence factor for resource Rᵢ, and
rᵢ represents resource distribution function for resource Rᵢ.

Resource distribution function rᵢ for M difference resources can be represented in terms of resource Rⱼ mobility group size N as follows:

rⱼ=Gⱼ(Rⱼ,N),∀ⱼ=1 . . . M.

The group predictor 216 operates on a mobility group or a batch of multiple VMs that is to be migrated. It uses adaptive iterative estimation by leveraging the aforementioned prediction engine. In an embodiment, the group predictor 216 employs the following algorithm.

Algorithm 1: Group Prediction(InitialPredictionArray,
i, GroupSize)

```
Data: [Pₓ_{ᵢ}, Pₓ_{ᵢ₊₁}, Pₓ_{ᵢ₊₂}, ... , Pₓ_{_{N}}], i, N
if N == 1 then
  | return [Pₓ_{ᵢ}, Pₓ_{ᵢ₊₁}, ... , Pₓ_{_{N}}]
end
Sort initial prediction array in ascending order for all VMs ∈ [i, N].
Calculate new prediction for all VMs ∈ [i + 1, N].
Adjust vm characteristic vector C′ₓ_{ᵢ} = D(Cₓ_{ᵢ}, Cₓ_{_{i−1}}).
Here function “D” factors in
    remaining vm data to be migrated.
      P′ₓ = F(C′ₓ|r′₁, r′₂ ... r′_{M}, w₁, w₂ ...
w_{M}), r′ⱼ = Gⱼ(Rⱼ, N − 1), ∀ⱼ∈ [1, M]
  AdjustedPredictionArray = [Pₓ_{ᵢ}, P′ₓ_{ᵢ₊₁}, P′ₓ_{ᵢ₊₂}, ... , P′ₓ_{_{N}}]
  return GroupPrediction(AdjustedPredictionArray, i+1, N−1)
```

Each system has resources (bandwidth, processing capacity, disk IO etc.). These resources are finite and are equally available to each participating migration. That is, if the total resources are represented by R and the mobility group size is N, then each migration gets a share R/N of the resources available.

When a VM migration is complete, it frees up its share of resources making it available for the remaining active (N−1) migrations. Hence, the resources available for each migration are now R/(N−1). Availability of additional resource will speed up the migration process.

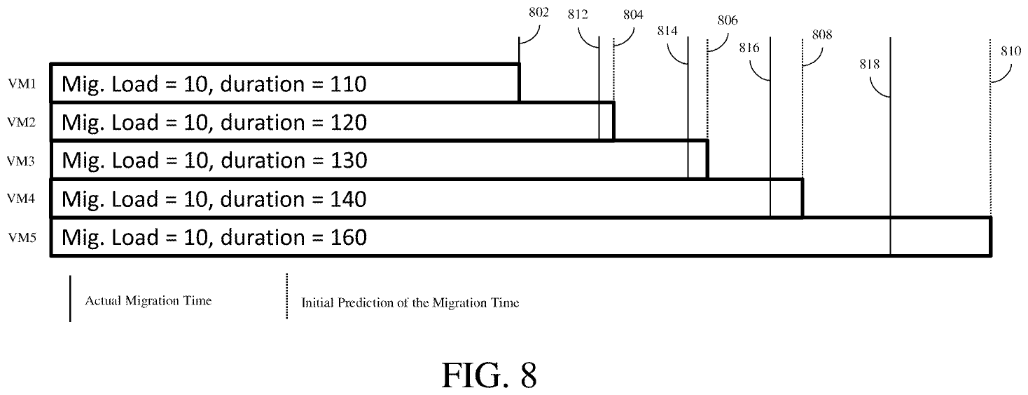

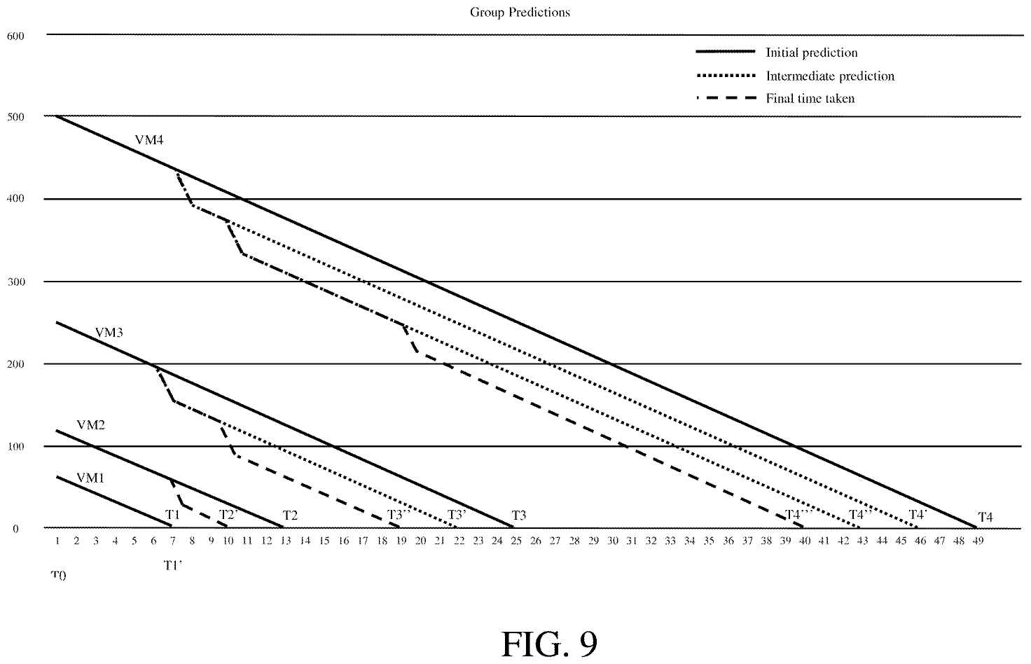

Consider a mobility group or a batch of five (5) VMs, which are identified as VM1, VM2, VM3, VM4 and VM5, that need to be migrated as shown in FIG. 8. Initial predictions for VM1, VM2, VM3, VM4 and VM5 without factoring in iterative resource availability are shown with the dotted lines 802, 804, 806, 808 and 810, respectively. Going by this approach, the mobility group seems to require 160 units of time to migrate all the VMs in the group, i.e., when VM5 has migrated. With the improved iterative predictions, the original migration times for VM2, VM3, VM4 and VM5 get readjusted as shown with the solid lines 812, 814, 816 and 818, respectively. The migration time for VM1 does not get readjusted because it is the first VM to finish migration and no resources are released to decrease its migration time. The algorithm has an ability to look into the future resource availability upfront and can present a near perfect view of the migration time of the VM group as a whole. FIG. 8 illustrates the initial predictions and final predictions for a mobility group. The process of making the initial and final predictions for a mobility in accordance with an embodiment of the invention is described below using an example illustrated in FIG. 9.

As shown in FIG. 9, a batch of VMs, or a mobility group with four VMs, which are identified as VM1, VM2, VM3 and VM4, is being analyzed by the prediction subsystem 208. The four (4) VMs have different characteristics, i.e., the VMs can vary in disk size, memory, CPUs, source datastore type, target datastore type, the type of application it runs and many more.

Each of these VMs is subjected to the prediction engine 218 to get the completion times of migration for VM1, VM2, VM3 and VM4 as T1, T2, T3, and T4, respectively, where T1<T2<T3<T4. Each of these migration completion times denotes the initial prediction time for the corresponding VM to complete its migration. The migration completion times T1, T2, T3 and T4 are for VM1, VM2, VM3 and VM4, respectively. The longest migration time for any of the VMs in the mobility group is considered the completion time for the mobility group, which is T4 for VM4 in this case. The total resources of the system, i.e., bandwidth, processing speed, source and target disk IOPS etc., is represented as “R”, which is the value of the aggregated resources.

In FIG. 9, the time TO represents the time when the migration of the batch of four VMs has just started but no migrations are actually running yet. At time TO, each migration gets R/4 share of the aggregated resources.

At time T1, when the first migration, i.e., the migration for VM1, is complete, the remaining active migration count is 3. With the change in the group size, each migration can now claim R/3 share of the aggregated resources. Since R/4<R/3, each migration can now proceed at a faster pace compared to the time prior to T1.

The change in the underlying resource claim mandates a correction in the prediction time. Accordingly, the new predictions are calculated, T2′, T3′ and T4′, where T2′<T2, T3′<T3 and T4′<T4.

At time T2′, the migration for VM2 is complete and each of the remaining migrations for VM3 and VM4 can claim R/2 resources for their migrations, where R/3<R/2. This again mandates a correction in the prediction times for VM3 and VM4 since each migration can now proceed at a faster pace compared to the time before T2′. The new predictions for VM3 and VM4 are T3″ and T4″, respectively, where T3″<T3′<T3, T4″<T4′<T4, and T3″<T4″.

Similarly, at time T3″, when the migration for VM3 is complete, the remaining migration for VM4 has full access to the resources since it is the only migration running, i.e., it can claim R/1 or R resources for its migration. This means the migration will now proceed faster than before the time before T3″. Hence, a new prediction is mandated. The new prediction for VM4 is T4′″, where T4″<T4″<T4′ <T4.

Note that for the first migration of VM1, the initial completion time T1 equals the final completion time T1′, or T1=T1′. This is because there is no way to claim extra resources prior to the time T1.

In summary, each time a migration completes, the time taken to perform the rest of the migrations changes since more resources are available. This is represented in the graph of FIG. 9. When VM1 completes migration, the updated prediction times for the migrations of VM2, VM3 and VM4 are T2′, T3′ and T4′, respectively. When VM2 completes migration, the updated times for the migrations of VM3 and VM4 are T3″ and T4″, respectively. When VM3 completes migration, the updated time for the migration of VM4 is T4′″. In general, time Tnf represents the final time taken for migration to complete, where f is n−1 number of prime symbols. Times T2′, T3″ and T4′″ represent Tnf for VM2, VM3 and VM4, respectively. For some migrations, there will be intermediate prediction times between the original initial prediction and the final prediction times. For example, the time T3′ for VM3 and the times T4′ and T4″ for VM4 represent the intermediate prediction times to complete the migrations of VM3 and VM4.

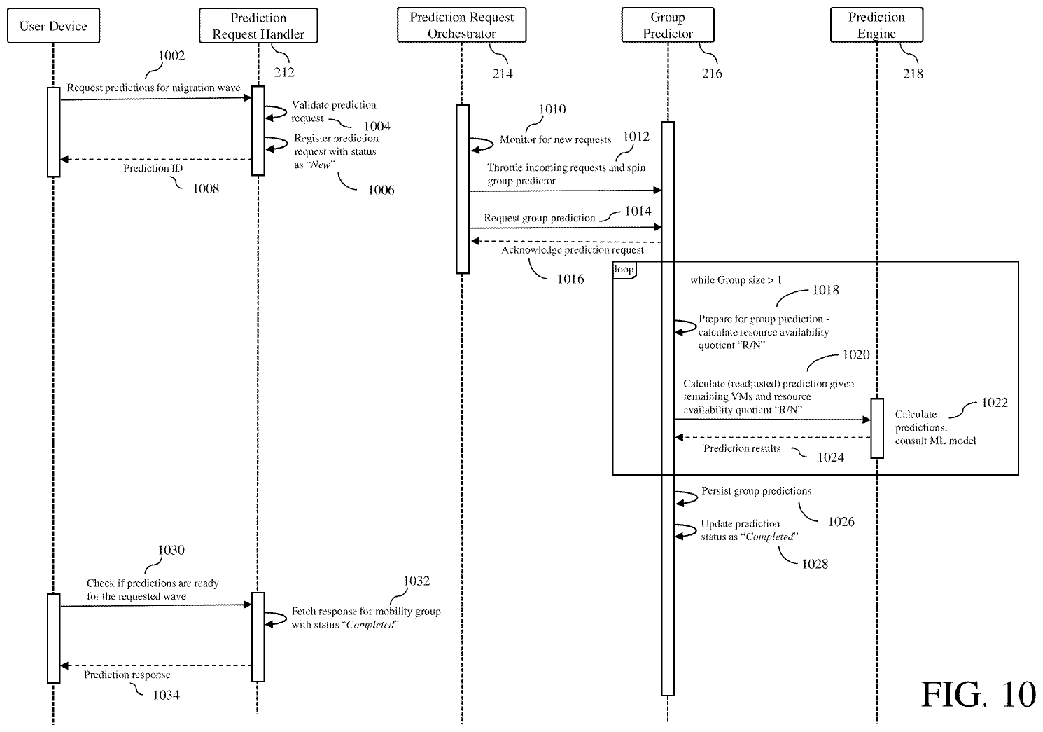

The prediction operation of the prediction subsystem 208 in accordance with an embodiment of the invention is illustrated in FIG. 10. The prediction operation begins at step 1002, where a prediction request for a migration wave or a mobility group is sent to the prediction request handler 212 from a user on a user device. At step 1004, in response to the prediction request for the migration wave, the prediction request is validated by the prediction request handler 212. In an embodiment, validations may include checking presence of all the attributes required to carry out the prediction, checking that the migration in fact has not started already, and other sanity checks.

Next, at step 1006, the prediction request is registered with status as “New” by the prediction request handler 212, which indicates that the prediction request needs to be processed. At step 1008, a prediction identification (ID) for the prediction request is sent to the user device from the prediction request handler 212. The prediction ID can be used by the user to fetch prediction results once they are ready.

Next, at step 1010, the prediction subsystem 208 is monitored for prediction requests registered as “New” by the prediction request orchestrator 214. At step 1012, the number of registered prediction requests that will be picked up for processing is throttled by the prediction request orchestrator 214. Since group migration predictions are compute-intensive task, the prediction requests need to be throttled to avoid overwhelming the system. In addition, at step 1012, a group predictor 216 is spun or rapidly created by the prediction request orchestrator 214 for each new prediction request for a migration wave being processed.

Next, at step 1014, a request for group migration prediction is transmitted to the new group predictor 216 from the prediction request orchestrator 214. At step 1016, in response to the group prediction request, an acknowledgement signal is transmitted to the prediction request orchestrator 214 from the group predictor 216.

Next, steps 1018-1024 are executed for the migration wave as long as the group size is greater than one (1) to produce prediction results for the migration wave. At step 1018, preparations are made by the group predictor 216 for the group prediction. In an embodiment, VM traits and system traits in terms of metrics are captured by the group predictor 216. Furthermore, a vector is created out of these metrics and the resource availability quotient “R/N” is calculated by the group predictor 216. Next, at step 1020, a request to calculate migration predictions given the remaining migrating VMs in the mobility group and the current resource availability quotient “R/N” is sent to the prediction engine 218 from the group predictor 216, where N is the original group size minus any VMs in the mobility group that have completed their migrations.

Next, at step 1022, in response to the request, migration predictions are calculated by the prediction engine 218 using one or more machine learning models 210 on the VMs of the mobility group that have not yet completed their migrations and the total resource availability. Next, at step 1024, the prediction results generated by the prediction engine 218 are transmitted to the group predictor 216. Steps 1018-1024 are repeated until final predictions have been made for each of the VMs in the mobility group.

Next, at step 1026, the final predictions for the VMs in the mobility group are saved in any persistent storage by the group predictor 216. Next, at step 1028, the status of the prediction request is updated as “Completed” by the group predictor 216.

Next, at step 1030, a prediction status for a mobility group is requested from the prediction request handler 212 by the user on the user device using the prediction ID for the mobility group. At step 1032, in response to the request, the prediction results for the mobility group associated with the prediction ID are fetched by the prediction request handler 212. Next, at step 1034, a prediction response with the final prediction requests for the mobility group is transmitted to the user device from the prediction request handler 212. The prediction response may also include the prediction ID and the status of the prediction request, which in this example is “Completed” status. If the status of the prediction ID is anything other than “Completed”, the prediction response may simply include the prediction ID and the status of the prediction ID. The operation then comes to an end.

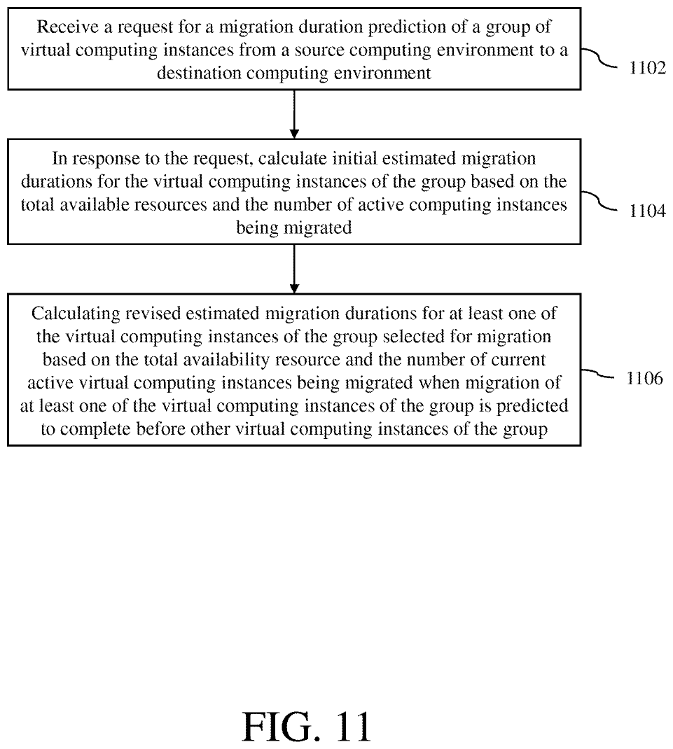

A computer-implemented method for predicting durations for virtual computing instance migrations between computing environments in accordance with an embodiment of the invention is described with reference to a process flow diagram of FIG. 11. At block 1102, a request for a migration prediction duration of a group of virtual computing instances from a source computing environment to a destination computing environment is received. At block 1104, in response to the request, initial estimated migration durations for the virtual computing instances of the group are calculated based on a total availability resource and number of active virtual computing instances being migrated. At block 1106, revised estimated migration durations for at least one of the virtual computing instances of the group selected for migration are calculated based on the total availability resource and a number of current active virtual computing instances being migrated when migration of at least one of the virtual computing instances of the group is predicted to complete before other virtual computing instances of the group. The revised estimated migration durations are associated with the migration duration prediction for the group of virtual computing instances from the source computing environment to the destination computer environment.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include a compact disc with read only memory (CD-ROM), a compact disc with read/write (CD-R/W), a digital video disc (DVD), and a Blu-ray disc.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method for predicting durations for virtual computing instance migrations between computing environments, the method comprising:
receiving a request for a migration duration prediction of a group of virtual computing instances from a source computing environment to a destination computing environment;
in response to the request, calculating initial estimated migration durations for the virtual computing instances of the group based on total available resources and a number of active virtual computing instances being migrated; and
calculating revised estimated migration durations for at least one of the virtual computing instances of the group selected for migration based on the total available resources and a number of current active virtual computing instances being migrated when migration of at least one of the virtual computing instances of the group is predicted to complete before other virtual computing instances of the group, wherein the revised estimated migration durations are associated with the migration duration prediction for the group of virtual computing instances from the source computing environment to the destination computer environment.

2. The method of claim 1, wherein calculating the initial estimated migration durations includes calculating the initial estimated migration durations for the virtual computing instances of the group based on the total available resources divided by the number of virtual computing instances in the group.

3. The method of claim 1, wherein calculating the revised estimated migration durations includes calculating the revised estimated migration durations for at least one of the virtual computing instances of the group selected for migration based on the total available resources divided by the number of current active virtual computing instances being migrated.

4. The method of claim 1, wherein calculating the revised estimated migration durations is iteratively executed as long as a number of the virtual computing instances of the group selected for migration is greater than one.

5. The method of claim 1, wherein calculating the initial estimated migration durations includes calculating the initial estimated migration durations for the virtual computing instances of the group using traits of the virtual computing instances in the group and system traits of the source and destination computing environments.

6. The method of claim 5, wherein the traits of the virtual computing instances in the group includes traits of virtual machines in the group.

7. The method of claim 1, wherein calculating the initial and revised estimated migration durations includes employing machine learning models.

8. A non-transitory computer-readable storage medium containing program instructions for predicting durations for virtual computing instance migrations between computing environments, wherein execution of the program instructions by one or more processors causes the one or more processors to perform steps comprising:
receiving a request for a migration duration prediction of a group of virtual computing instances from a source computing environment to a destination computing environment;
in response to the request, calculating initial estimated migration durations for the virtual computing instances of the group based on total available resources and number of active virtual computing instances being migrated; and
calculating revised estimated migration durations for at least one of the virtual computing instances of the group selected for migration based on the total available resources and a number of current active virtual computing instances being migrated when migration of at least one of the virtual computing instances of the group is predicted to complete before other virtual computing instances of the group, wherein the revised estimated migration durations are associated with the migration duration prediction for the group of virtual computing instances from the source computing environment to the destination computer environment.

9. The non-transitory computer-readable storage medium of claim 8, wherein calculating the initial estimated migration durations includes calculating the initial estimated migration durations for the virtual computing instances of the group based on the total available resources divided by the number of virtual computing instances in the group.

10. The non-transitory computer-readable storage medium of claim 8, wherein calculating the revised estimated migration durations includes calculating the revised estimated migration durations for at least one of the virtual computing instances of the group selected for migration based on the total available resources divided by the number of current active virtual computing instances being migrated.

11. The non-transitory computer-readable storage medium of claim 8, wherein calculating the revised estimated migration durations is iteratively executed as long as a number of the virtual computing instances of the group selected for migration is greater than one.

12. The non-transitory computer-readable storage medium of claim 8, wherein calculating the initial estimated migration durations includes calculating the initial estimated migration durations for the virtual computing instances of the group using traits of the virtual computing instances in the group and system traits of the source and destination computing environments.

13. The non-transitory computer-readable storage medium of claim 12, wherein the traits of the virtual computing instances in the group includes traits of virtual machines in the group.

14. The non-transitory computer-readable storage medium of claim 9, wherein calculating the initial and revised estimated migration durations includes employing machine learning models.

15. A system comprising:
memory; and
one or more processors configured to:
receive a request for a migration duration prediction of a group of virtual computing instances from a source computing environment to a destination computing environment;
in response to the request, calculate initial estimated migration durations for the virtual computing instances of the group based on total available resources and a number of active virtual computing instances being migrated; and
calculate revised estimated migration durations for at least one of the virtual computing instances of the group selected for migration based on the total available resources and a number of current active virtual computing instances being migrated when migration of at least one of the virtual computing instances of the group is predicted to complete before other virtual computing instances of the group, wherein the revised estimated migration durations are associated with the migration duration prediction for the group of virtual computing instances from the source computing environment to the destination computer environment.

16. The system of claim 15, wherein the one or more processors are configured to calculate the initial estimated migration durations for the virtual computing instances of the group based on the total available resources divided by the number of virtual computing instances in the group.

17. The system of claim 15, wherein the one or more processors are configured to calculate the revised estimated migration durations for at least one of the virtual computing instances of the group selected for migration based on the total available resources divided by the number of current active virtual computing instances being migrated.

18. The system of claim 15, wherein the one or more processors are configured to iteratively execute calculations of the revised estimated migration durations as long as a number of the virtual computing instances of the group selected for migration is greater than one.

19. The system of claim 15, wherein the one or more processors are configured to calculate the initial estimated migration durations for the virtual computing instances of the group using traits of the virtual computing instances in the group and system traits of the source and destination computing environments.

20. The system of claim 19, wherein the traits of the virtual computing instances in the group includes traits of virtual machines in the group.
